(19) United States
(12) Patent Application Publication
(10) Pub. No.: US 2003/0229632 A1
(43) Pub. Date: Dec. 11, 2003

(54) Communications system and method

(76) Inventor: Mark Harris, Clearbrook, VA (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/276,082

(22) PCT Filed: May 15, 2001
(86) PCT No.: PCT/US01/15594

(51) Int. Cl. G06F 7/00

(52) U.S. Cl. 707/3

(57) ABSTRACT

A method of processing a domain name tree is disclosed. The domain name tree includes a domain name segment and at least one undefined sub-domain segment. Command parameters are extracted from the sub-domain segment and are converted to terms, such as search terms, address fields and the like. The terms are then manipulated, either under a predefined process or a dynamically selected process identified by attributes of the domain name tree or other data. A result is thus derived from the extracted terms.

### CROSS REFERENCE TO RELATED APPLICATION

This application claims priority under 35 U.S.C. § 119(e) and incorporates by reference U.S. Provisional Application No. 60/204,251, filed May 15, 2000.

### BACKGROUND OF THE INVENTION

The present invention relates to art of computer networks and their interaction with other systems. It finds particular application in conjunction with the use of the Domain Name System (DNS) for parameter-based commands issued over networks, and in conjunction with electronic mail (email) addressing systems for computer networks and, accordingly, will be described with particular reference thereto. However, it is to be appreciated that the present invention is also amenable to other like applications.

The Internet is a constantly expanding network of computer networks with various kinds of information and services. Commands are used to access these information and services by the trillions each day. While these commands are used over the Internet, similar commands are regularly employed on intranets and other networks in countless numbers as well. Over networks, especially over Internet protocol networks, many of these commands are issued by individual people. Therefore, it is desirable to streamline the command issuing process, whenever possible.

There are many different types of commands. Input commands are used to retrieve information. Output commands are used to send information. Processing commands are used to manipulate and change information. For the purposes of this invention, we will focus on parameter-based commands as opposed to direct commands with no parameters.

A parameter-based command is a “standard order given with modifying details”. For instance, within a universal resource locator (URL) box on a web browser, you may type: www.domain.com. This is a command to go to that specific Internet address. In this case, each Internet domain is a direct command with no parameters.

If you were to type: www.domain.com/users, this would be a command to go to that Internet address and then specifically to go to the “users” sub-directory. The “/users” component of this command would be a parameter to the command, in other words, items following a forward slash typically supply modifying details.

The following is an example of how cumbersome and complex modifying details or parameter-based commands have become (note—while illustrated on two lines here, the actual command occupies one line in a browser location window):

www.altavista.com/cgi-bin/query?pg=q&sc=on&hl=on&q=springfield+pizza+delivery+&kl=XX&stype=stext

This is an altavista.com URL for use in a search engine command. This command is fairly incomprehensible to most, but it provides critical information to the search engine. While user inability to comprehend the commands is clearly illustrated in the search engine context, this drawback is shared over most of the internet protocol addressing system. Accordingly, due to the familiarity of search engines and their dependence on parameters, the examples herein will use search engine commands with the understanding that these examples are merely illustrative of more pervasive problems.

Thus the search engine paradigm illustrates many of the problems associated with parameter-based network commands. For example, it often takes many steps to get answers. Indeed, most search engines require five steps to get relevant answers from the initial seeking of the search engine home page to the review of results. As another example, users expend much time waiting for intermediate pages to load. Further, additional time is required for the user to wade through often irrelevant up-front pages, instead of proceeding directly to desired or applicable pages. Still more time is wasted on irrelevant information in the form of diversionary links and ads that may get clicked, thereby taking the user away from the task at hand. Additionally, data entry locations are often not intuitive or are inconsistent between various search engines. In other words, more time is spent moving around the page to input information for a search, for example, first entering the URL to get to the search page, then locating the search box of some kind, somewhere on the search page.

Continuing, especially with URL-parameter-based commands, there is no inherent feedback or update loop with the command giver. Specifically, the command givers are not known, nor is it known how to reach them to follow-up on their commands. As an example consider the typical action of submitting a search request to a search engine and obtaining results. What if, however, right after obtaining the results, unknown to the command giver, a match for that which was being sought was just posted? Presently, the command giver will never know, or at least will not know until another search is performed or the command giver registers for a periodic search update service. Of course, registration is a complex task, time consuming and frustrating to users. Updating would be possible with parameter-based commands sent via email; however, that brings with it, a new set of challenges.

Moreover, while communication connectivity continues to improve especially through email, increased use is revealing drawbacks to the present system. For example, fast growth has forced many companies and many individuals to acquire an email address. In fact, many companies and individuals have several different email addresses and accounts. This growth, totaling in the multiple trillions of dollars worldwide, has also spawned legislation such as the US Telecommunications Reform Act of 1996. This legislation has created a flood of new companies, products and services, all of which desire new levels of flexibility.

However, more that 70% of the world is not on the Internet. Put another way, of the approximately 100 million businesses in the world, only 30% have an Internet web site, email address and the like. This means that for the 30% who use email, which can be quick and easy, it is often more expensive and time consuming to communicate with someone without such a presence. Worse, without a preexisting relationship, even the privileged 30% do not know if a specific potential customer, contact or recipient even has an email address.

In accordance with aspects of the present invention, a dramatic improvement is realized for many of these problems.

### BRIEF SUMMARY OF THE INVENTION

In an embodiment of the present invention, sub-domains of network addresses that use DNS-like structure for parameter placeholders are used to issue commands instead of host addresses. This is more fully described below. However, a brief example is as follows:

If you were to enter into a URL box in a browser: www.telenumber.com, you would expect to go to the world wide web host site “www.telenumber.com”. This command has no parameters. It is just linked to an IP address on a server.

On the other hand, assuming that “telenumber.com” is a search engine, and, a user desires to search for Cleveland pizza places. In accordance with the present invention, the user may type (i.e., for a search engine embodiment):

cleveland.pizza.telenumber.com

This would “pass” the parameters (variables): “Cleveland” and “pizza” to the search engine and go straight to a results page for: Cleveland pizza.

For email-parameter-based commands, the command may look as follows:

search@cleveland.pizza.telenumber.com

This would “pass” the parameters or terms: “Cleveland” and “pizza” to an email based search engine and send the search results for “Cleveland and pizza” to the senders reply email address.

Another embodiment of the present invention is directed to is a process used to improve an Internet or intranet email system. The method involves someone “creating” an email address or virtual email address for most if not all telephone numbers in a given area accessible through a single domain. An example is:

John.Smith@1.440.354.3479.Telenumber.com

For example, a covered “regional” area could be an area code, city, state, nation, or the world. The domain and how the telephone number is included in the email address may take different forms. However, it is desirable that the format of the telephone number within the domain remains consistent. This will allow anyone knowing the addressing format to properly address an email message to any “telephone number” in the world (or region covered) through that given domain.

Accordingly, a substantially higher ratio of successfully sent emails is realized in accordance with the present invention. The reason for this is that an email message can be completed even if the owner/subscriber of the telephone number or their agent, doesn't have a current email address or email account. Herein, we will refer to this prospective recipient of the email as the “subscriber.”

Preferred delivery options are obtained from the subscriber. The email address itself is what gives us the ability to obtain these delivery options from the subscriber via the telephone number included in the email address as entered by the email sender. An aspect of this email addressing system is that not only does the subscriber need not have a current email address, but also, the delivery options can be obtained after the email message has been sent. Typically, a particular delivery mode is designated for a specific recipient before the message can be sent and delivered.

If an email message is sent to an email address using the present invention, the system has either:

A) Already obtained the subscribers preferred delivery options for that address; or,

B) Has not obtained the subscribers preferred delivery options for that address.

If the system already has the subscriber's delivery options, the email will be routed accordingly.

If the system has not obtained the subscribers preferred delivery options, then the system initiates an appropriate “call” to the telephone number to obtain the selection from the subscriber directly.

A sample call to a subscriber's regular telephone number may be scripted as follows:

[DIAL SUBSCRIBERS TELEPHONE NUMBER, WAIT FOR ANSWER, UPON ANSWERING]

Hello, John Smith, an Internet telephone email message is waiting to be delivered to you from “Joe Sender”

To direct this message to an Internet email address of your choice, PRESS 1

To direct this message to a fax machine of your choice, PRESS 2

To have this message spoken to you, PRESS 3

To have this message mailed to you via the postal service, PRESS 4

To have this message viewed on a web page, PRESS 5

To have this message permanently destroyed without delivering it to you, PRESS 6

To learn more about Internet telephone email—preferred delivery options, PRESS 9

After the subscriber selects their options, the email message is converted if necessary, and sent via the delivery vehicle of their choice. With the present invention, more people can get more email messages through to their intended recipient.

In accordance with an embodiment of the present invention a method of processing a domain name tree includes receiving the domain name tree including a domain name segment and a sub-domain segment. A processor is identified from the domain name segment, and at least one command parameter is selected from the sub-domain segment . Under control of the identified processor, the selected command parameters are converted to terms, such as search terms or alternate address components, configured for further processing.

In accordance with an aspect of the present invention, the method includes passing the terms converted from the selected command parameters to a search engine to be searched or operated upon. The results of the search engine operation are received and provided to a user, for example via reply email or directing a browser to a results page.

In accordance with an aspect of the present invention, the method includes parsing the terms for separating characters indicative of predefined Boolean operations and forwarding the Boolean operations to the search engine to be operated upon with others of the terms.

In accordance with an aspect of the present invention, the method includes receiving with the domain tree, data such as an email message, to be forwarded on an alternate service. The terms converted from the selected command parameters are processed into an alternate service address and the data is forwarded to the address via the alternate service.

In accordance with an aspect of the present invention, the method includes confirming delivery of the data via the alternate service to a user.

In accordance with an aspect of the present invention, the method includes identifying a telephone number from data including the terms converted from the selected command parameters and delivering data associated with the domain name tree to a recipient identified by the telephone number.

In accordance with an aspect of the present invention, the method includes selecting a delivery method hierarchy for data directed to the telephone number and attempting delivery of the data according to the selected delivery method hierarchy.

In accordance with another embodiment of the present invention, a method for passing non-addressed sub-domain information as parameter-based command criteria to a host computer is provided. It works with networks that use multiple domain levels as is common on the Internet and most intranets using the Domain Name System (DNS). Starting with any domain name or network address using the multiple domain level system, single or multiple parameters separated by dots are prefixed to some working domain name and thereby passed to some search engine, database, processor, etc. The dots act to separate the different parameters and act much like Boolean operators (and, or, not, etc.) that separate the parameters in a Boolean search. In this case, “and” would be a typical default Boolean operator. Parameters passed this way take on the same characteristics as other full domain names, however they are not addressed to host computers as typically done. The process for creating sub-domains as non-hosts, not directly tied to individual IP addresses is fully detailed in DNS and BIND by Paul Albitz & Cricket Liu, incorporated in its entirety herein by reference.

Other aspects and advantages of the present invention will become apparent to those of ordinary skill in the art upon reading and understanding the following detailed description of the preferred embodiments.

### BRIEF DESCRIPTION OF THE DRAWINGS

The invention may take form in certain parts and arrangements of parts and in various steps and arrangement of steps. The drawings are only for purposes of illustrating the exemplary embodiments and are not to be construed as limiting the invention.

FIG. 1 is a representation of a typical network addressing system or domain name structure;

FIG. 2 is a typical search engine URL usable by the present invention;

FIG. 3 is flowchart suitable to practice an embodiment of this invention;

FIG. 4 is an exemplary screen shot of an email search suitable to practice an embodiment of this invention;

FIG. 5 is another exemplary screen shot of an email forwarding service suitable to practice an embodiment of this invention;

FIG. 6 is flowchart suitable to practice another embodiment of this invention;

FIG. 7 is another exemplary screen shot of another forwarding service suitable to practice an embodiment of this invention; and

FIG. 8 is yet another exemplary screen shot of another forwarding service suitable to practice an embodiment of this invention.

### DESCRIPTION OF THE PREFERRED EMBODIMENTS

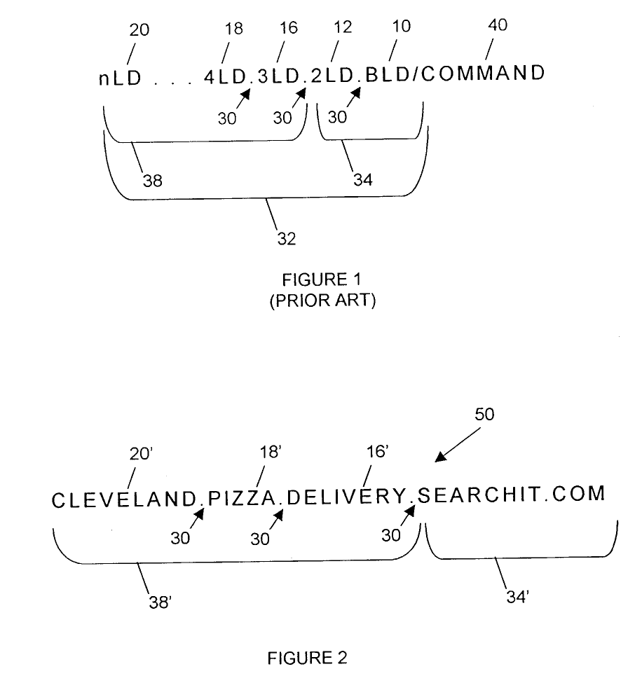

With reference to FIG. 1, existing domain name structures include a base level domain (BLD) 10, otherwise known as a “top level domain” or a “first level domain.” Base level domains 10 are not associated with an IP address itself but are a logical grouping used to distinguish between, for example, countries (e.g., .US, .CA, .UK, .HK, etc.), colleges (e.g., .EDU), US military (e.g., .MIL), US government (e.g., .GOV), corporations (e.g., .COM, .ORG), Internet service providers (ISPs) (e.g., .NET) and the like. These base level domains 10 manage inquiries to the second level sub-domains 12.

The second level sub-domain (2LD) 12 is normally associated with an IP address when used in conjunction with a BLD 10. Examples of a second level domain name are IBM as used in IBM.COM, or OSU as used in OSU.EDU. The second level domain 12 usually manages any inquiries to the third level sub-domain 16. The third level sub-domain (3LD) 16 is also normally associated with an IP address when used in conjunction with a second level sub-domain 12 and a base level domain 10 (i.e. .2LD.BLD). An example of a third level domain name is: SUPPORT, as used in SUPPORT.IBM.COM. The third level sub-domain 16 usually manages any inquiries to the fourth level sub-domain 18.

The fourth level sub-domain (4LD) 18 is usually associated with an IP address when used in conjunction with a third level sub-domain 16, second level sub-domain 12 and a base level domain 10 (i.e. .3LD.2LD.BLD). Some examples of a fourth level domain name include: PC or AIX as used in PC.SUPPORT.IBM.COM or AIX.SUPPORT.IBM.COM. The fourth level sub-domain 18 usually manages any inquiries to the next domain and so on to the Nth level domain 20. The Nth level domain 20 represents any and all higher level domains. The N is representative of any and all higher level domains (i.e., 2, 3, 4, 5, 6, etc.).

All domain names can contain word(s) or a phrase consisting of letters, numbers, and certain punctuation marks or characters, (a . . . z, 0 . . . 9, etc.). The “dot,” or domain separator 30 typically separates domain name levels. This separator 30 is used to designate managing control of higher domain levels to their next lower domain level.

Thus, complete domain names or domain name trees 32 consist of two parts: a base level or domain name segment 34 and a sub-domain segment 38. Within the Internet's DNS system, a domain name segment 34 contains a .BLD 10, and optionally, any number of upper level sub-domains 12, 16, 18, 20. Some examples of domain name segments 34 are single level segments (e.g., .COM, .NET, or any .BLD); and multi-level segments (e.g., IBM.COM, ABC.DEF.ORG, one.two.three.four.five.six.NET, etc.). Sub-domain segments 38, on the other hand, are any group of one or more discrete “names” separated by a period “.” that does not contain a .BLD 10. Some examples of sub-domain segments 38 are single level segments (e.g., ABC, IBM, telenumber, etc.); and multi-level segments; (e.g., ABC.DEF, Support.IBM, one.two.three.four.five.six, etc). These segments 34, 38 when combined form a complete domain name or a domain name tree 32.

With continued reference to FIG. 1, domain name trees 32 may optionally contain parameters or commands 40 typically separated by forward slashes “/” 42. When these commands 40 contain difficult but required syntax, they are usually derived by a hosting computer from user entries into form-like boxes on a web page. While functional, this system adds additional steps or page views before the user obtains a first hint at the desired information.

Referring now to FIG. 2, an embodiment of the present invention includes commands 50 placed partially or entirely in a sub-domain segment 38′ as sub-domains 16′, 18′, 20′ which are passed to the host computer. In the illustrated example the sub-domains 16′, 18′, 20′ include search parameters prefixed to a sub-domain segment 38′. This sub-domain segment 38′ is then passed through to a host, search engine, database, etc. which processes the commands 50 and gives results. The host, for example, is identified by the domain name segment 34′. In one respect, this method avoids the somewhat longer and confusing method currently used by many search sites. Those skilled in the art can now appreciate that the disclosed sub-domain-based command is easily understood and realizes a simple method of sending command parameters to a host.

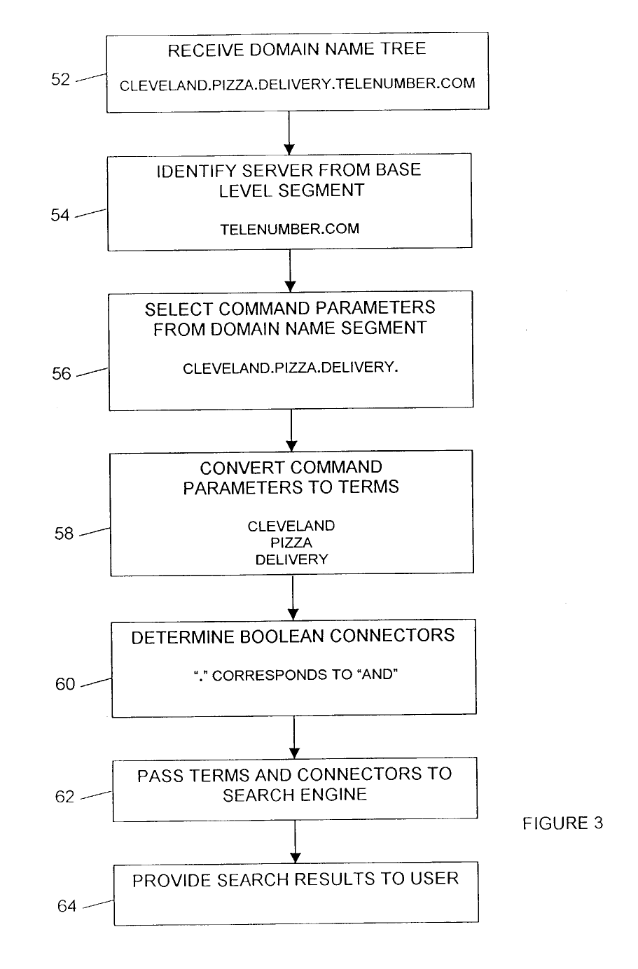

Referring now to FIG. 3, an exemplary flowchart of the embodiment of FIG. 2 begins with receipt of the domain name tree 32′ by a host processor as seen in step 52. If the domain name segment 34′ is not identified, it is extracted as seen in step 54. A processor then selects command parameters 50 from the sub-domain segment 38′ as seen in step 56. The selected command parameters 50 are converted into terms, such as search terms, address fields or other data as seen in step 58. Separators 30 are parsed and appropriate Boolean operators are assigned as seen in step 60. The terms and Boolean operators are passed to a search engine as seen in step 62, and the results are provided to the user as seen in step 64.

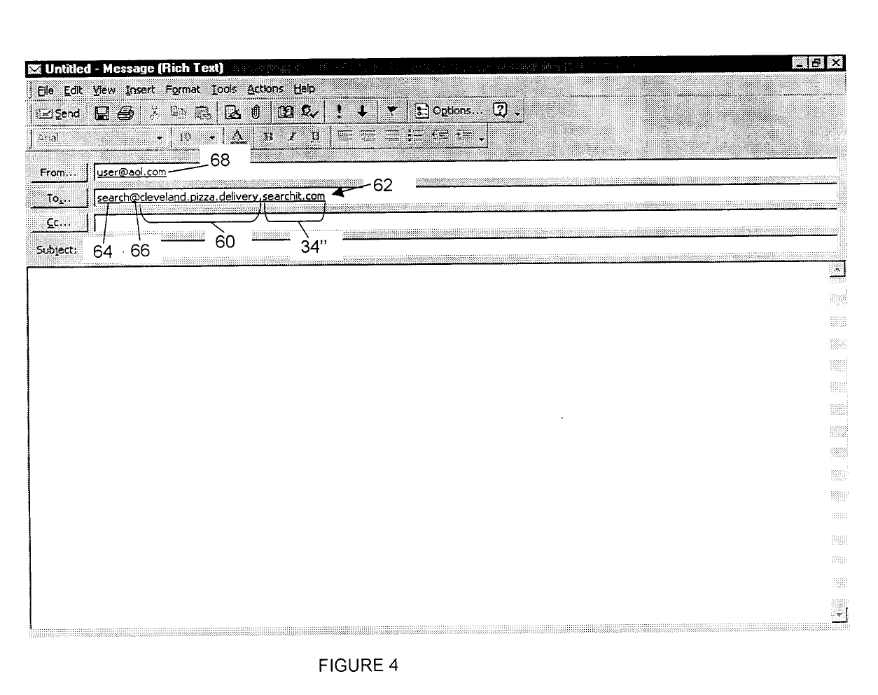

Referring now to FIG. 4, another embodiment of the present invention includes a request formatted as an email message. The email message includes search parameters or other parameters 60 to be passed to a host in an email address 62. In this instance, the host is identified by the base level-like segment 34″ and is separated from other commands 64 by the at symbol, “@” 66. Artisans can appreciate that additional information, parameters or commands may optionally be disposed in the subject, body, and/or attachment sections of an email message to add further functionality. Desirably, the sender's email address 68 is forwarded along with the request, enabling the host to auto-reply- results of the command to the sender's email address. Additionally, the other commands field 64 may employ definitions for Boolean operators such as “search.and” where the separator is listed and followed by the definition. Further separators and definitions may be appended as necessary.

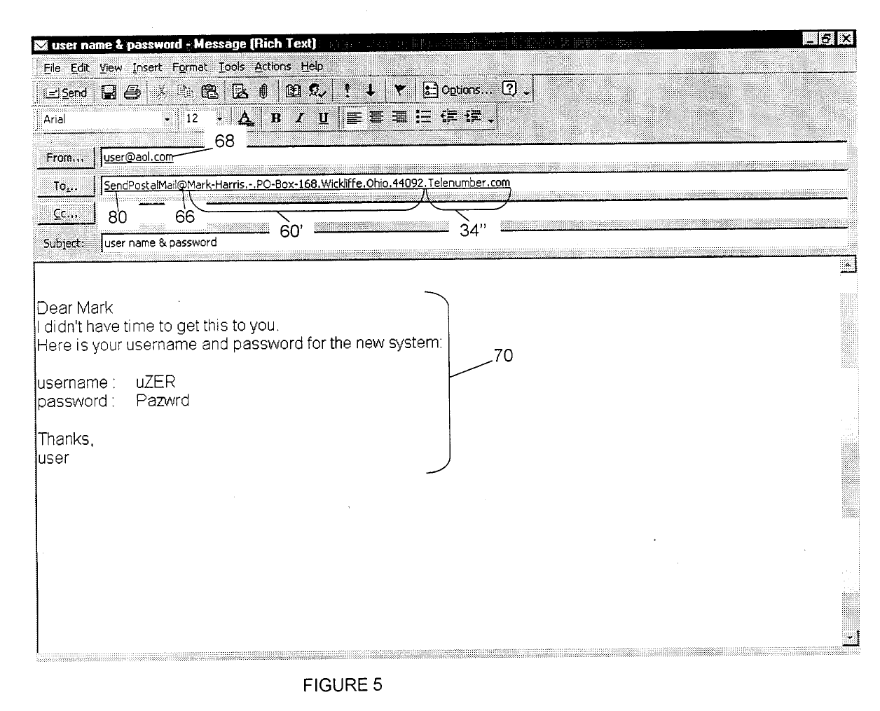

With reference to FIG. 5, another embodiment that suitably practices the invention includes a postal mailing service for email messages. In the particular example illustrated, the sender would use the their email client application and insert parameters 60′ appended onto the base level-like segment 34″ following the at symbol “@” 66. These parameters 60′ provide an address mechanism permitting a receiving host, identified by the base-level segment 34″, to forward the email body 70 to a service for printing and/or delivery to an address indicated by the address parameters 60′.

As suggested above, the body 70 of the email message would be “the message to be sent”. This is one example of a command line that the sender has been pre-instructed to use when it is desired to deliver email messages using postal-type addressing, for example the following command format:

SendPostalMail@Firstname-Lastname.Company.Street-address.City.State.zipcode telenumber.com

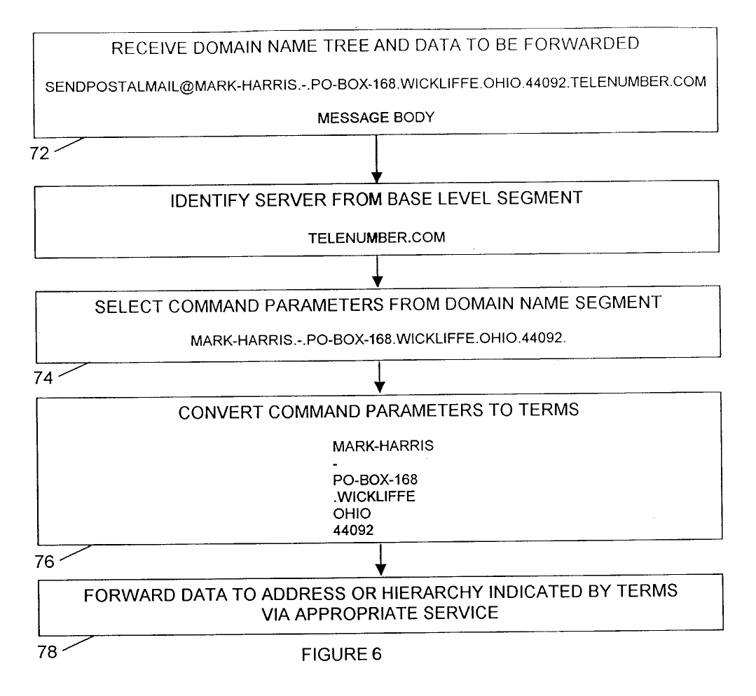

Referring now to FIG. 6, an exemplary flowchart of the embodiment of FIG. 5 begins with receipt of the domain name tree and data to be forwarded, as seen in step 72. The base level 34″, here telenumber.com, includes an email system set up as discussed in the above referenced processes to take the sub-domain names 60′ (handled as parameters) and pass them to a processor as field variables, as seen in step 74. To continue, the processor converts the parameters into fields such as:

| Name | Mark Harris |
|---|---|
| Company | |
| Street Address | PO Box 168 |
| City | Wickliffe |
| State | Ohio |
| Zipcode | 44092 |

as seen in step 76. The dash “-” between two dots “.” within the command line is a blank field. A dash “-” between letters is a space, although those skilled in the art can appreciate that almost any pre-designated character can indicate a space with equal efficacy. The processor forwards the data 70 to the address identified by the fields as seen in step 78. In one example, this passed data is then used to print off a mailing label; and the body of the message is printed, placed into an envelope or onto a postcard that has the label affixed for postal mailing. Those skilled in the art can appreciate that the “address” can alternately be any suitable identifier such as the postal address illustrated, an electronic mail address, a telephone number, and the like.

Additional commands 80 optionally are prefixed, for example, prior to the at symbol “@” 66 and can include routing, handling and other like instructions. Those skilled in the art can now appreciate that this embodiment desirably enables a user to “email” a person knowing only a traditional postal mail address, or other identifier such as a telephone number and the like. Additionally, other message delivery mechanisms such as fax, voice mail, telephone call, text messaging to mobile devices and the like can be substituted with no loss of functionality.

The above domain, Telenumber, may alternately be setup with multiple commands called a command environment. The specific command 80 was given within the user name section of the email address. This command was: “SendPostalMail”. However, Telenumber.com could have been setup as a single command domain. Then no command within the username would be used, and anything could occupy that place. In other words, other delivery options or addressing capabilities may occupy this place. For example, the received address could alternately be formatted as name@address.domain_name_segment, or to continue the present example, mark.harris@.-. PO-Box-168.Wickliffe.Ohio.44092.Telenumber.com.

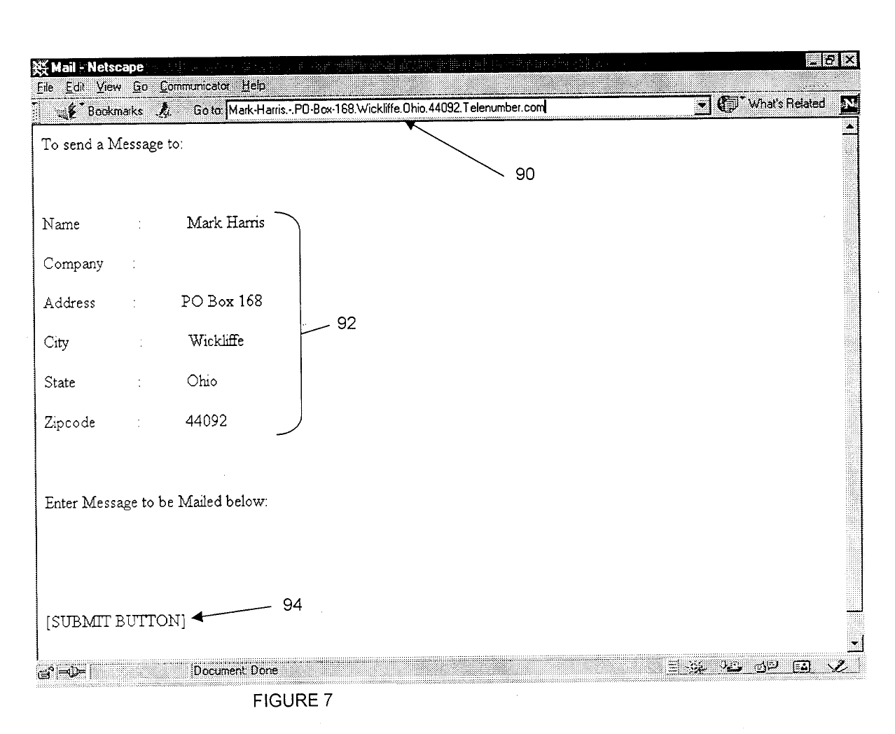

Referring now to FIG. 7, a World Wide Web/URL/Html embodiment includes an address 90 in the command line of a browser window. Here the server or processor identified by “telenumber.com” parsed the address 90 and identified the listed fields 92 from the address, specifically,

| Name | Mark Harris |
|---|---|
| Company | |
| Street Address | PO Box 168 |
| City | Wickliffe |
| State | Ohio |
| Zipcode | 44092 |

The user verifies the accuracy of the address, types in the body of a message and indicates completion, for example by clicking a Submit button 94. The domain telenumber.com receives the information via HTTP and performs the same task as the email version discussed above.

In the illustrated example telenumber.com is a single command domain. So, it automatically knew that the user desired to send a postal message. However, where the domain offers various functionality, command environments are established where the specific command would also be “entered” using a web browser URL, such as:

URL: Mark-Harris.-.PO-Box-168.Wickliffe.Ohio.44092.Telenumber.com/SendPostalMail

This has the user putting the specific command for telenumber.com, i.e. SendPostalMail, into the “directory” section of the URL. However, the command parameters are still within sub-domain-names as passed variables. Moreover other addressing formats are interchangeable as discussed above.

Some additional search engine examples follow:

| Search Criteria | Sub-domain segment | Domain Name Segment | Internet Domain Name |
|---|---|---|---|
| Pizza, visa, Chicago | pizza.visa.chicago | .anything.BLD | pizza.visa.chicago.anything.BLD |
| 90210, High school | 90210.high.school | .searchit.BLD | 90210.high.school.searchit.BLD |
| Mels | mels | .very.long.domain.name.BLD | mels.very.long.domain.name.BLD |
| Pizza, Akron, visa | pizza.akron.visa | .telenumber.com | pizza.akron.visa.telenumber.com |

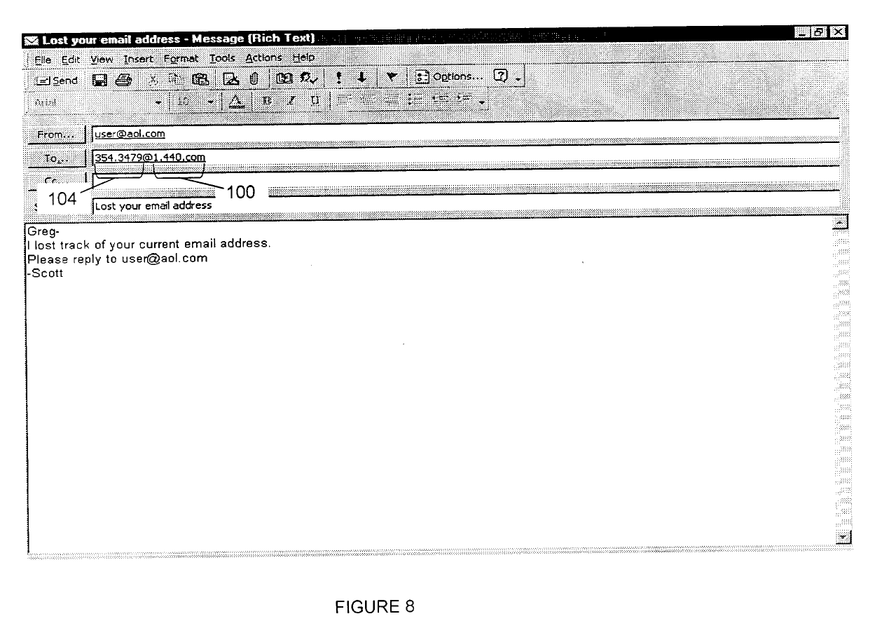

Referring now to FIG. 8 an alternate embodiment is illustrated where a sub-domain includes several digits of a telephone number 100. The host processor extracts command parameters from, in the illustrated example, the sub-domain segments 100 and the address portion 104. In the example, the format is established where the country code, 1, and the area code 440 form sub-domains, while the remainder of the number lies in the address portion 104. These are converted into a telephone number, which is then called to either deliver the message or to ascertain alternate delivery options. Preferably, the telephone call is carried out using an Interactive Voice Response (IVR) system, although it could easily be accomplished live operators, or in some combination thereof, where, if a subscriber doesn't make a choice using the IVR system, an operator gets on the line or calls back. Those skilled in the art can appreciate that different phone number portions can reside in different parts of the address and that the illustration is exemplary only.

Some other numbers such as fax numbers, pager numbers and voice mail numbers may have their own variations on how the delivery options will be obtained. Here are a few examples of delivery options:

Fax numbers: The IVR system that calls the telephone number, uses an auto-fax detection device. This device informs the system that the telephone number in question is a fax number. The system could then fax to the subscriber, a Subscriber Preferred Delivery Options Form. It would inform them that they have a pending email much like the IVR script described above. This fax form could be pre-coded to automatically “read” it after it is faxed back in by the subscriber. This fax reading system would then know who the fax was from, how they wanted their email delivered, and to where. This system could then route it appropriately as the subscriber desired.

Voicemail numbers: The IVR system that calls the telephone number, uses an auto-voicemail detection device. This device informs the system that the telephone number in question is a voice mail number. The system could then, on the same call, attempt to leave a message to the subscriber. This message would inform them that they have a pending email much like the beginning of the IVR script described above. In the message, the system would also leave a telephone number to call for the subscriber to finish the IVR call as described above. When calling, the subscriber would enter in the telephone number that was called (the telephone number from the original email), so the system will know which message to administer. After receiving the delivery options, the system could then route the email message appropriately as the subscriber desired.

Pager Numbers: The IVR system that calls the telephone number, uses an auto-pager detection device. This device informs the system that the telephone number in question is a pager number. The system could then, on the same call, attempt to leave a telephone number for the subscriber to call. When the Subscriber calls the number, the message would inform them that they have a pending email much like the IVR script above. When calling, the subscriber would enter in the telephone number that was called (the telephone number from the original email), so the system will know which message to administer. After receiving the delivery options, the system could then route the email message appropriately as the subscriber desired.

Functionally Limited Telephone Numbers: When the IVR system runs into a type of number that it cannot handle as suggested above, or as various other types of numbers processes are detailed out, many times a live operator can be used to initially identify the type of number that the email addressed. For example: The IVR system may call another IVR system. This system may not have message capacity or the ability to speak with a live person. Some telephone numbers are rarely if ever answered, such as a Security line for a home or business, which is used to call the police or fire department. Some telephone numbers are modem lines. In these cases where an operator may be able to identify what type of number it is, but may not be able to go further, one approach would be to do, telephone number cross referencing. This may allow the system to find out whom the number belongs to by various directory or other sources. Then, we can call the party in question and complete the email delivery. These types of phone numbers will be “marked” in our system, so that future emails to these types of telephone numbers will be handle more smoothly.

Delivery Options: When a subscriber is giving their preferred delivery options, they will be asked how they would like future email messages to be delivered. If they choose fax only, then email messages will automatically be faxed thereinafter. No telephone call to the subscriber is made, only a fax call. The same could go for spoken only, mailed only, or emailed to the email address of their choice. Some subscribers will choose various versions of enhanced email accounts. This would allow the email messages to go right into a pop3 account which is the actual email address sent. Alternately, other types of email accounts could also be set up such as webmail accounts.

Some subscribers may opt to choose each time an email message comes in, or to redirect the message to one of the other delivery media. Also, they may desire to have this choice made by the IVR call each time, or by fax, mail, email, or to go to a web site to make the choice. Each of these delivery mechanisms will have the options to direct or redirect the message to another location of their choice. The system will “remember” their preferred addresses for telephone numbers (maybe even mobile phone numbers for remote email notification, fax numbers, mailing addresses, email addresses, and web addresses that they access this related information.

In a preferred embodiment, a single Internet or intranet domain is employed, however, for simplicity herein, reference will only be made to an “Internet” domain. A few examples of Internet domains are “.com”, “telenumber.com”, or even “tele.nmbr.net”. “.com” is an example of an Internet “top-level” domain.; and “telenumber.com” is a 2nd level domain with “.com” being the “top-level” of that domain. The “telenumber” part is called a “sub-domain” or “the 2nd level” of the domain. In our 3^{rd} example: “.net” is the top-level domain, “nmbr” is a sub-domain of “.net”, and the 3^{rd} level of the domain is “tele”. The domain is the “tele.nmbr.net” domain. For our example, we will use the domain “telenumber.com”

Since a domain has been selected, and since we have decided to use this process in an Internet email system, we will now gain “control” of the domain through the usual processes.

Next, we will select our operating system and servers. This could be Windows NT, Unix or Linux to name a few. We will use Linux for our example, specifically Red Hat Linux 6.0. We will then set up the DNS records and configure the email system appropriately for use. There are 2 books that describe in detail this UNIX specific process; DNS and BIND by Paul Albitz & Cricket Liu 1998, and Red Hat Linux 6 Unleashed-David Pitts, Bill Ball which are both incorporated herein by reference. When we are finished, our servers will be connected to the Internet and our domain, Telenumber.com will be pointing to our name servers and our IP addresses on our system.

Next, we will set up our system to ADD email addresses to our domain. In this example, we will use an email program call“sendmail” and we will use the processes laid out within the book: SendMail 2^{nd} edition By Bryan Costales & Eric Allman. This book is incorporated herein by reference. As described, email addresses are formatted as:

username@domain.com

Next, we will then “create” an email address for every telephone number in a given area such as the United States or even the whole world. For our example, we will create an email address within our selected domain (telenumber.com) for every telephone number in the world. There are many ways that an email address can be incorporated into a domain in a consistent format. These variations include: The option of having separators or not having them. These separators can be dots “.” or dashes “-” or other possibilities. The telephone number can be all together or split up into different pieces and moved around. The telephone number can be within one domain or in sub domains. In can also be split up across many sub domains. Additionally, it could be put partially or fully within the user name section.

Here are some examples of how telephone numbers can be used within an email address:

### I. Using the Telephone Number Within the User Name

| | Starting | Starting |
|---|---|---|
| EMAIL ADDRESS | TELEPHONE # | DOMAIN |
| 14403543479@telenumber.com | Telephone # | Domain: |
| | 1-440-354-3479 | telenumber.com |
| 1.440.354.3479@telenumber.com | Telephone # | Domain: |
| | 1-440-354-3479 | telenumber.com |
| 1-440-354-3479@telenumber.com | Telephone # | Domain: |
| | 1-440-354-3479 | telenumber.com |

### II. Using the Telephone Number Split up across a User Name and Domain (or Sub-Domain)

| | | |
|---|---|---|
| 3543479@1440.com | Telephone # 1-440-354-3479 | Domain: |
| | | 1440.com |
| 3543479@440.US.com | Telephone # 1-440-354-3479 | Domain: |
| | | 440.US.com |
| 354-3479@1-440.com | Telephone # 1-440-354-3479 | Domain: |
| | | 1-440.com |

### III. Using the Telephone Number as a Sub-Domain of a Domain

| | | |
|---|---|---|
| anything@1-4403543479.Telenumber.com | Telephone # 1-440-354-3479 | Domain: telenumber.com |
| anything@1-440-354-3479.Telenumber.com | Telephone # 1-440-354-3479 | Domain: telenumber.com |
| anything@1-440-354-3479.com | Telephone # 1-440-354-3479 | Domain: .com |

### IV. Using the Telephone Number Across Multiple Sub-Domains (Each Dot “.” Is a Domain Level Separator)

| | | |
|---|---|---|
| anything@1.440.354.3479.shop | Telephone # 1-440-354-3479 | Domain: .shop |
| anything@1.440.354.3479.Telenumber.com | Telephone # 1-440-354-3479 | Domain: telenumber.com |

The last example of a telephone number within an email address will be used within our example, even though any of these, or other formats would work just as easily.

Since, for our example, we are putting up every telephone number in the world within the telenumber.com domain, we will need to make sure all the numbers are there so as to be able to “dial” the number. In our case, we will need to incorporate the country code, “1”, the area code “440”, and the telephone number “354.3479”. If we were just doing the United States, we would not have to have the “1” within each email address, because we know that we would have to dial the “1” before the call could go through.

In this example, we are going to go through a more manual approach to using the preferred invention. This embodiment would have us initially with no one in the world who has given us his or her preferred delivery options. One way to handle this somewhat effectively is to instruct upfront, those setting up the email addresses for each telephone number in the world (mentioned above), forward every single email address to one central email address. This would allow all email messages from each and every of the telephone number email addresses to go to a call center. To share the load, groups of the email addresses could be sent to regions, i.e., German telephone numbers to a call center in Germany. This is done by city, state, country, region, industry, or whatever other central grouping is desired.

Since no subscriber has yet, in this example, given us their delivery preferences, any emails to any telephone number email address would go to some call center. When an email sender, would send an email message, formatted using any predetermined format, to the telephone number email address, it will be forwarded to the call center. (If this example were an IVR example, as mentioned above, the email would be routed to an IVR system.) Assume the email message sender talked to a friend who said:

“Hey Joe, you can put any telephone number into this email address format: ‘anything@1.440.354.3479.telenumber.com,’ and they will route it to the email address of the individual or company who owns that telephone number. If they don't have one on file, they will call them up and get it. If they don't have one, they will speak the message, fax it, mail it, or even publish it on the web. The only way it doesn't get there, is if the recipient rejects it.”

Assuming Joe (the sender) wanted to send an email to someone who ran a classified ad in the newspaper he got while he was out of town. Lets assume that the number was 1-312-222-3333. Joe would use his email software and Internet service provider to send the email to the following address:

anything@1.312.222.3333.telenumber.com

Joe asks for information about the baseball card collection for sale and asks for a returned call and a pricing. Notice Joe converted the telephone number into the properly formatted email address. Joe sends the message.

Now, an individual (which we will refer to as the Operator), within the call center, receives the email message. The Operator picks up a telephone and dials the telephone number as formatted within the email message, which is 1-312-222-3333. At this point, the operator proceeds to follow a manual process doing the same things the IVR system did in the IVR example above. Primarily, this means they will obtain the preferred delivery options from the subscriber, and then, proceed to manually convert and deliver, the email message to the subscriber. Also, the Operator would ask the subscriber, how they would like to handle future emails. In this example, we will show how the operator could fulfill the delivery of the emailed message in much the same way as the IVR system example. Each subscriber preference listed below will give a possible scenario for the Operator.

EMAIL Preference—When the subscriber chooses to have the message emailed to them. The Operator goes to the email software client where they received the senders telephone number email message, and use a standard FORWARD function included with most email clients such as Eudora, Microsoft Outlook, or Lotus Notes. The message would be forwarded to the email address given by the subscriber. Also, if the client wanted to have all future messages emailed, the Operator could go to the email server(s) and change the forwarding. Future messages would not go to the call center but to the new forwarding address as changed in the email system, using the email address given by the subscriber. If the Operator, within a remote call center did not have access to the email server(s) they could forward a change order request to an email change specialist located at the email server(s) location. When the Operator was finished, they could then record the transactions in a file on the subscriber, or in an appropriate database program.

FAX Preference—When the subscriber chooses to have the message faxed to them. The Operator goes to the email software client where they received the senders telephone number email message, and uses a standard PRINT or PRINT-FAX function included with most email clients such as Eudora, Microsoft Outlook, or Lotus Notes. The fax functionality is offered with programs such as Winfax or Microsoft Fax. If the Operator printed out the email message, this printed document would be faxed using a standard stand-alone fax machine. The message would be faxed to the fax number given by the subscriber. Also, if the client wanted to have all future messages faxed, the Operator could go to the email server(s) and change the forwarding to a Fax-only Operator who would take any future incoming email messages and send them to the subscriber using the process mentioned above. The Fax-only Operator would probably use the shared filing system or database as a “central” place for all subscriber preferred deliver options. Future messages would not go to the call center but to the new forwarding address as changed in the email system, using a pre-established email address for the Fax-only operator(s). If the Operator, within a remote call center did not have access to the email server(s) they could forward a change order request to an email change specialist located at the email server(s) location. When the Operator was finished, they could then record the transactions in a file on the subscriber, or in an appropriate database program (Central Subscriber Options Database).

SPOKEN Preference—When the subscriber chooses to have the message spoken to them. The Operator goes to the email software client where they received the senders telephone number email message, and then reads the email message to the subscriber. Also, if the client wanted to have all future messages spoken to them, the Operator could go to the email server(s) and change the forwarding to a Spoken-only Operator who would take any future incoming email messages and call and read them to the subscriber. The Spoken-only Operator would probably use the shared filing system or database as a “central” place for all subscriber preferred deliver options so they would have the information need to fulfill the subscribers requests. Future messages would not go to the call center but to the new forwarding address as changed in the email system, using a pre-established email address for the Spoken-only Operator(s). If the Operator, within a remote call center did not have access to the email server(s) they could forward a change order request to an email change specialist located at the email server(s) location. When the Operator was finished, they could then record the transactions in a file on the subscriber, or in an appropriate database program (Central Subscriber Options Database)

POSTAL MAIL Preference—When the subscriber chooses to have the message mailed to them. The Operator goes to the email software client where they received the senders telephone number email message, and uses a standard PRINT function included with most email clients such as Eudora, Microsoft Outlook, or Lotus Notes. This printed document would be mailed to the postal mailing address given by the subscriber. Also, if the client wanted to have all future messages mailed, the Operator could go to the email server(s) and change the forwarding to a Mail-only Operator who would take any future incoming email messages and send them to the subscriber using the process mentioned above. The Mail-only Operator would probably use the shared filing system or database as a “central” place for all subscriber preferred deliver options. Future messages would not go to the call center but to the new forwarding address as changed in the email system, using a pre-established email address for the Mail-only Operator(s). If the operator, within a remote call center did not have access to the email server(s) they could forward a change order request to an email change specialist located at the email server(s) location. When the Operator was finished, they could then record the transactions in a file on the subscriber, or in an appropriate database program (Central Subscriber Options Database)

WEB VIEWED Preference—When the subscriber chooses to have the message viewed on the web. The Operator would give the subscriber a web page address to view in a given amount of time (let's say 30 minutes). Then, the Operator goes to the email software client where they received the sender's telephone number email message, and uses a standard SAVE AS (text) function included with most email clients such as Eudora, Microsoft Outlook, or Lotus Notes. This saved text document would be convert into an html page using any text-to-html software such as Microsoft Word. Then the html document would be uploaded to the web address given to the subscriber. Also, if the client wanted to have all future messages viewed on the web, the Operator could go to the email server(s) and change the forwarding to a Web-view-only Operator who would take any future incoming email messages and publish them on the web for the subscriber. The Web-view-only Operator would probably use the shared filing system or database as a “central” place for all subscriber preferred deliver options. Future messages would not go to the call center but to the new forwarding address as changed in the email system, using a pre-established email address for the Web-view-only Operator(s). If the Operator, within a remote call center did not have access to the email server(s) they could forward a change order request to an email change specialist located at the email server(s) location. When the Operator was finished, they could then record the transactions in a file on the subscriber, or in an appropriate database program (Central Subscriber Options Database)

ASK ALWAYS Preference—When the subscriber chooses to be asked about each message. The Operator would follow the appropriate directions for each document delivery means above. Then, since the subscriber wants to be asked about all future messages, the Operator would leave the email server(s) just as they are. This would have future email messages go back to the call center each time.

SUBSCRIBER DESTROY DOCUMENT Preference—When the subscriber chooses to have the message destroyed. The Operator goes to the email software client where they received the senders telephone number email message, and uses a standard DELETE function included with most email clients such as Eudora, Microsoft Outlook, or Lotus Notes. Also, an email message may be sent back to the sender, notifying them that the message was rejected. Also, if the client wanted to have all future messages destroyed, the Operator could go to the email server(s) and change the forwarding to a Destroy-only Operator who would take any future incoming email messages and destroy them for the subscriber. The Destroy-only Operator would probably use the shared filing system or database as a “central” place for all subscriber preferred deliver options. Future messages would not go to the call center but to the new forwarding address as changed in the email system, using a pre-established email address for the Destroy-only Operator(s). If the Operator, within a remote call center did not have access to the email server(s) they could forward a change order request to an email change specialist located at the email server(s) location. When the Operator was finished, they could then record the transactions in a file on the subscriber, or in an appropriate database program (Central Subscriber Options Database).

Other Options

1) The subscriber could get other information directly from the Operator.

2) The subscriber could call the call center to change their delivery options.

3) Most of the processes mentioned above may be automated.

The invention has been described with reference to the preferred embodiments. Obviously, modifications and alterations will occur to others upon reading and understanding the preceding description it is intended that the invention be construed as including all such modifications and alterations insofar as they come within the scope of the appended claims or the equivalents thereof.

Having thus set forth the preferred embodiments, the invention is now claimed to be:

1. A method of processing a domain name tree comprising:
receiving the domain name tree including a domain name segment and at least one sub-domain segment;
extracting at least one undefined command parameter from the sub-domain segment;
converting the extracted undefined command parameters to terms; and
manipulating the terms to arrive at a result derived from the terms.

2. The method of processing a domain name tree as set forth in claim 1, where the manipulating comprises:
passing the converted terms to a search engine to be operated upon;
receiving a result of the search engine operation; and
providing the result to a user.

3. The method of processing a domain name tree as set forth in claim 2, further comprising:
parsing the sub-domain segment for separating characters indicative of predefined Boolean operations; and
providing representations of the predefined Boolean operations to the search engine to be operated upon with others of the terms.

4. The method of processing a domain name tree as set forth in claim 1, where data to be forwarded on an alternate service is received with the domain tree, wherein the manipulating comprises:
assigning selected terms to address fields corresponding to an address on the alternate service; and
forwarding the data to the address via the alternate service.

5. The method of processing a domain name tree as set forth in claim 4, further comprising:
confirming delivery of the data via the alternate service to a user.

6. The method of processing a domain name tree as set forth in claim 1, wherein the manipulating comprises:
identifying a telephone number from data including the terms converted from the selected command parameters; and
delivering data associated with the domain name tree to a recipient identified by the telephone number.

7. The method of processing a domain name tree as set forth in claim 6, where the delivering data comprises:
selecting a delivery method hierarchy for data directed to the telephone number; and
attempting delivery of the data according to the selected delivery method hierarchy.

8. A method of searching comprising:
receiving an address comprising search parameters configured as sub-domains;
performing a search using the search parameters, the search returning a plurality of results; and
providing the plurality of results to a user.

9. The method of searching as set forth in claim 8, further comprising:
receiving an email address to which results of the search are to be provided.

10. The method of searching as set forth in claim 9, wherein the providing results step comprises:
sending the results of the performed search to the received email address.

11. The method of searching as set forth in claim 8, wherein the receiving an address step comprises:
receiving a URL directed to a domain name segment and at least one sub-domain.

12. The method of searching as set forth in claim 11, wherein the providing results step comprises:
redirecting a web browser to a page containing results of the performed search.

13. A method of redirecting an email message comprising:
receiving data including the email message and an address comprising command parameters configured as sub-domains;
processing the command parameters into an alternate delivery address; and
sending the email message to the alternate delivery address.

14. The method of redirecting an email message as set forth in claim 13, wherein the processing comprises:
converting the command parameters into. a postal mailing address.

15. The method of redirecting an email message as set forth in claim 13, wherein the processing comprises:
converting the command parameters into a telephone number.

16. The method of redirecting an email message as set forth in claim 15, wherein the processing further comprises:
calling the telephone number; and
determining a preferred delivery method for the email message.

17. The method of redirecting an email message as set forth in claim 13, wherein the processing comprises:
converting the command parameters into a first address; and
substituting a preferred second address for the first address.
